(19) United States
(12) Patent Application Publication
(10) Pub. No.: US 2025/0068322 A1
(43) Pub. Date: Feb. 27, 2025

(54) AN EYE TRACKING VIRTUAL REALITY DEVICE FOR VOICE TAGGING IN VIRTUAL ENVIRONMENT AND OPERATING METHOD THEREOF

(71) Applicant: Ismail Koçak, Istanbul (TR)

(72) Inventors: Zaid Kotyba Sheet, Istanbul (TR); Ismail Koçak

(21) Appl. No.: 18/722,461

(22) PCT Filed: Mar. 2, 2023
(86) PCT No.: PCT/TR2023/050206

§ 371 Date: Jun. 20, 2024

(30) Foreign Application Priority Data
Mar. 3, 2022 (TR) 2022/003184

(51) Int. Cl. G06F 3/0487; G06F 3/04815; G06F 3/16; H04N 13/383

(52) U.S. Cl. CPC G06F 3/0487; G06F 3/04815; G06F 3/167; H04N 13/383

(57) ABSTRACT

The invention relates to a virtual reality device (1) for including voice as a tool to add value and extra layer of information to the virtual environment comprises at least one image acquisition unit (1.1) for recording the environment and for augmenting into the virtual world and the real-world environment in the outside of the device (1), at least one speaker (1.6) for listening the tagged items, at least one strap (1.8) in the predetermined length and thickness and at least one sensor (1.9) for calculating distance from the device (1) to the object user is looking at and focusing on, at least one inner image acquisition unit (1.1) for recording the eye movement and determine the convergence and meiosis of the object captured by the said outer image acquisition unit (1.1), at least one inner voice acquisition unit (1.2) for recording the audio in stereo from the user while tagging the object on the focus, at least one user interface (1.5) is controlled and navigated through voice mainly as well as a set of control element (1.7) to navigate the augmented environment, at least one control/calculating unit (1.3) for controlling and navigating through an user interface (1.5), at least one peripheral display (1.4.1) for maintaining the stereoscopic illusion connected with at least one display adapter (1.4) is responsible for 0 displaying all the graphics and calculating the geometries and it communicate with the central processing unit (1.3.3) through the system bus and then output to the displays (1.4.1) of the device (1) which there is two of to create a stereoscopic image view of the world and also relates to an operating method (100).

### TECHNICAL FIELD OF THE INVENTION

The invention relates to an eye tracking virtual reality device for voice tagging in virtual environment and operating method thereof.

### PRIOR ART

In the state of the art, virtual reality (VR) products use cameras for mixed realities or augmented realities which immerses the individual into the experience making the experience of the digital world and the real world feel the same. The problem with this approach is that audio is left out of the picture and instead the whole experience focusses on the visual aspect of the experience and make the audio and voice as just an instrument to sell that visual illusion of the VR experience. However, in the state of the art products there is no voice and audio experience at the same time. Therefore, it is necessary to develop systems that turn the listed disadvantages into advantages in the state of the art. In the state of the art, a VR headset is mentioned in the patent which number is U.S. Pat. No. 9,063,330B2 and which was filed in 2015. The voice and eye tracking technology is not mentioned in the said patent. In addition, in the current technique, all the VR headsets have camera's to track the movement of the user in some way or another. However, there are no cameras outside and inside the headset at the same time.

All the state of art products has no way of tracking the movement of the user pupil (eyes), by calculating the convergance point of the pupil. For instance most of the current VR headsets use some sort of controllers to move around the virtual world. In prior art, the people would be needing hand to handle and move inside the VR world.

### BRIEF DESCRIPTION OF THE INVENTION

The aim of the invention is to propose an eye tracking virtual reality device for voice tagging in virtual environment and operating method thereof. In order to achieve this aim, the invention puts the voice and audio as the main focus of the user experience. The user is able to use his/her voice to control and manipulate the environment. In addition, the invention adds inputs to the augmented reality experience and indulge user into the metaverse of the virtual reality experience. In the other words, the main aim of the invention is to detect the user focal point in order to get a more accurate and immersing experience in VR.

The invention especially focuses on voice and eye tracking technology which has been never done before. The invention has camera's outside to track the user movement and also cameras inside to track the eye movement of the user in order to determine what the user is focusing on or what the user is currently looking at in the virtual world. This is important in order to record the user audio for that object that he's (or she's) looking at.

In the one embodiment, the device can determine the focus point of the user and thus can record audio input from the user for that specific object, but it is not limited to this embodiment.

Using some sort of controllers to move around the virtual world is not totally necessary because by determining the convergance points can be determined in the invention where the user want to move and move him/her to that direction.

Another advantage is that it is for medical purposes that people with disabilities can use. Also the technology used in the invention has potential to be used in the medical industry like in prosthetic hands etc. Needing a hand to handle in the invention is optional because he/she can move using his/her eye by tracking where he/she is looking at.

### DESCRIPTION OF THE FIGURES

FIG. 1. A schematic front view of the device.

FIG. 2. A schematic rear view of the device.

FIG. 3. A schematic side view of the device.

FIG. 4. A blog diagram of the method.

FIG. 5. A blog diagram of device's components.

### DETAILED DESCRIPTION OF THE INVENTION

### Description of the References in the Figures

For a better understanding of the invention, the elements illustrated in the figures are numbered as follows:
1. Device
   1.1. Image acquisition unit
   1.2. Voice acquisition unit
   1.3. Control/calculating unit
      1.3.1. Storage unit
      1.3.2. Input/Output unit
      1.3.3. Central Processing unit
      1.3.4. Communication adapter
      1.3.5. Network adapter
      1.3.6. Sensing unit
   1.4. Display adapter
      1.4.1. Display
   1.5. User Interface
   1.6. Speaker
   1.7. Control element
   1.8. Strap
   1.9. Sensor
   100. Method
      101. Receive input from image acquisition unit (1.1)
      102. Detect conversion points
      103. Detect Meiosis
      104. Detect voice acquisition unit (1.2) for speech input
      105. Wait for voice input
      106. Record audio tag
      107. Add audio tag to the virtual environment

The disclosed device (1) of the invention for including voice as a tool to add value and extra layer of information to the virtual environment comprises at least one image acquisition unit (1.1) for recording the environment and for augmenting into the virtual world and the real-world environment in the outside of the device (1) and also inner image acquisition unit (1.1) for recording the eye movement and determine the convergence and meiosis of the object captured by the said outer image acquisition unit (1.1), at least one inner voice acquisition unit (1.2) for recording the audio in stereo from the user while tagging the object on the focus which means that after determining the focal point with the user eyes then the voice acquisition unit's (1.2) starting record what the user is saying and record that as a tag to the object in the virtual world, at least one control/calculating unit (1.3) for controlling and navigating through an user interface (1.5), at least one peripheral display (1.4.1) for maintaining the stereoscopic illusion connected with at least one display adapter (1.4), at least one user interface (1.5) for ensuring the items such as menus, buttons, etc. that allows user to see and interact with them, at least one speaker (1.6) is inside the device (1) for using playback the recorded audio of the user and/or if the user interact with other users, it for recording any users the things they heard and their own comment on it, at least one control element (1.7), in the predetermined length and thickness at least one strap (1.8) for holding the device (1) to the user head and at least one sensor (1.9) for calculating distance from the device (1) to the object user is looking at and focusing on.

When the user records a tag the point which the user was focusing on will have a visual mark inside the virtual environment and the user will be able to replay the record, edit it or delete it and all of this will be done through the user interface (1.5) which will be presented to the user alongside the virtual environment of what the image acquisition unit (1.1) is recording.

The preferred embodiment of the invention, image acquisition unit (1.1) is a camera and voice acquisition unit (1.2) is a microphone and central processing unit (1.3.3) is a SoC system on a chip. The device (1) is a headset.

The preferred embodiment of the invention, the sensor (1.9) is a sensor. In one embodiment of the invention, the said sensor (1.9) is IR sensor (infrared sensor) calculating the distance from the device (1) to the object in front of it. In another embodiment of the invention, the sensor (1.9) is ToF (Time of Flight sensor) which gives also the distance to the desired object but it's more accurate under low light conditions. Sensor (1.9), also comprise any type of sensors that could be used to calculate object distance and combine it with the image acquisition unit's (1.1) data and it will give more accurate results as more sensors are added.

The control element (1.7) simulates hand movement in the virtual world and controls the user interface (1.5) with it. This could be a console controller or any other controlling device, all VR device (1) has some sort of controlling method to control the User Interface/Environment.

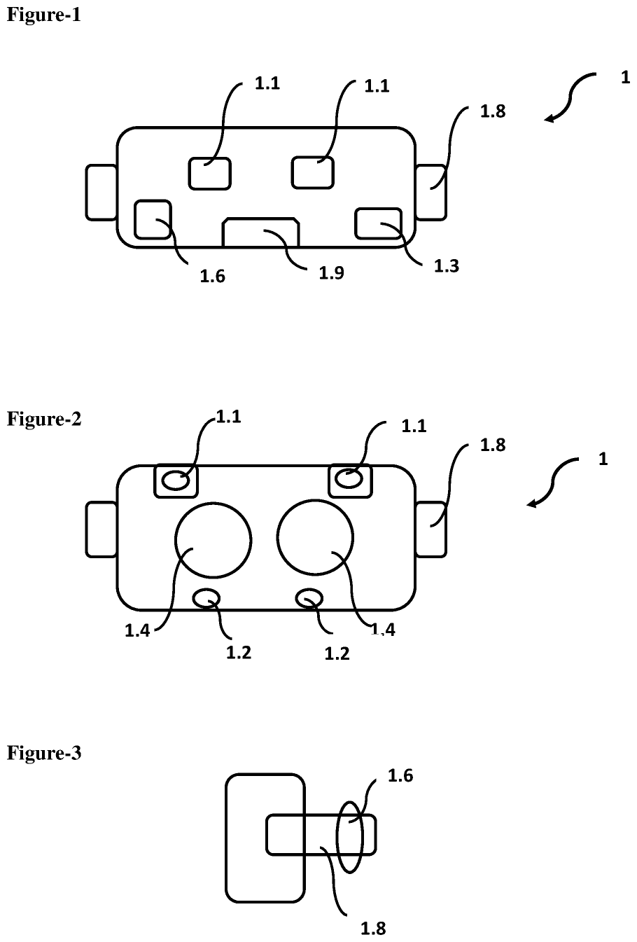

The figures (FIGS. 1, 2 and 3) contain a drawing of the different parts of the device (1) in different perspectives and describing the different components.

The control/calculating unit (1.3) comprises at least one storage unit (1.3.1), at least one input/output unit (1.3.2) includes any port used to interface with the headset such as USB, HDMI etc., at least one central processing unit (1.3.3) for doing all the calculation needed for the invention to function, at least one communication adapter (1.3.4) which is the chip responsible of communicating with the network adapter (1.3.5), at least one network adapter (1.3.5) that is responsible for wireless (WiFi and/or Bluetooth) functionality and at least one sensing unit (1.3.6) including all the sensors necessary for the function of the device (1).

Some embodiments of the invention, communication adapter (1.3.4) and/or network adapter (1.3.5) is part of the SoC (System On a Chip) and not as a separate part that communicate with the CPU. Another embodiments of the invention network adapter (1.3.5) is part of the an ARM RISC or X86. Reduced Instruction Set Computing (RISC) is used in smartphones and tablets because of it's smaller footprint and low power usage. X86 is the architecture used in desktop computer, laptops and servers.

A method (100) of the device subject to the invention comprise the following working steps;
the device (1) starts receiving data from at least one front image acquisition unit (1.1) (101) and calibrate the position of the user in the virtual environment (102)
meanwhile at least one image acquisition unit (1.1) positioned to inside the device (1) to record and detect the movement of the eyes pupil are calculating the convergence point in the environment to detect the point which the user is currently focusing on if the process is not finished successfully the said image acquisition units (1.1) start looking for meiosis in the pupil in the process (103)
if that process failed then the device (1) start receiving information from the image acquisition units (1.1) again or if the process is concluded successfully on either step of (102) or (103) then the device (1) start detecting the use speech input (104)
and at least one voice acquisition unit (1.2) on the device (1) start to record the digital audio (converting the analog audio to digital encoded audio file) from the user (106) and then add a tag marker on the point detected by the previous processes (102) and (103) which conclude the process (107).

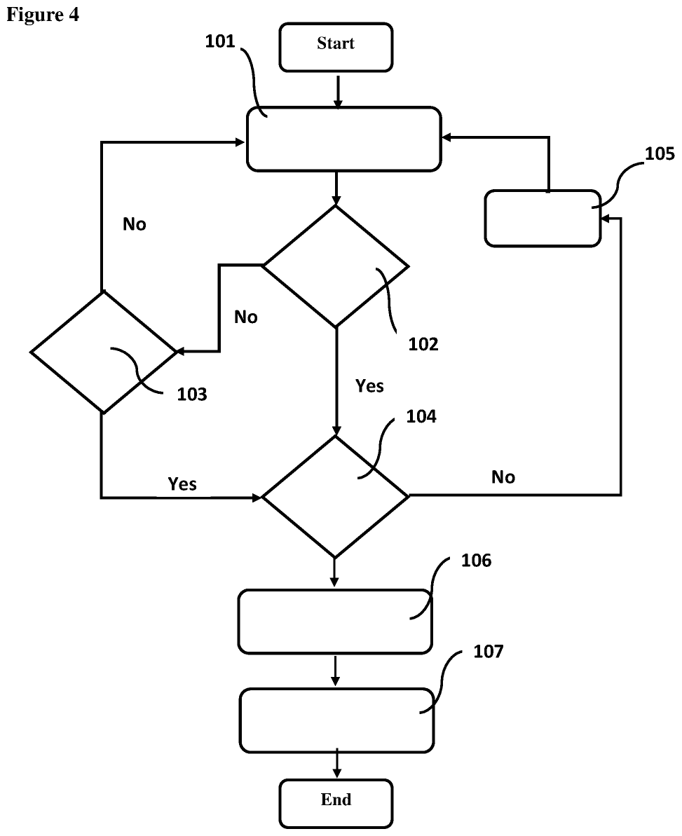

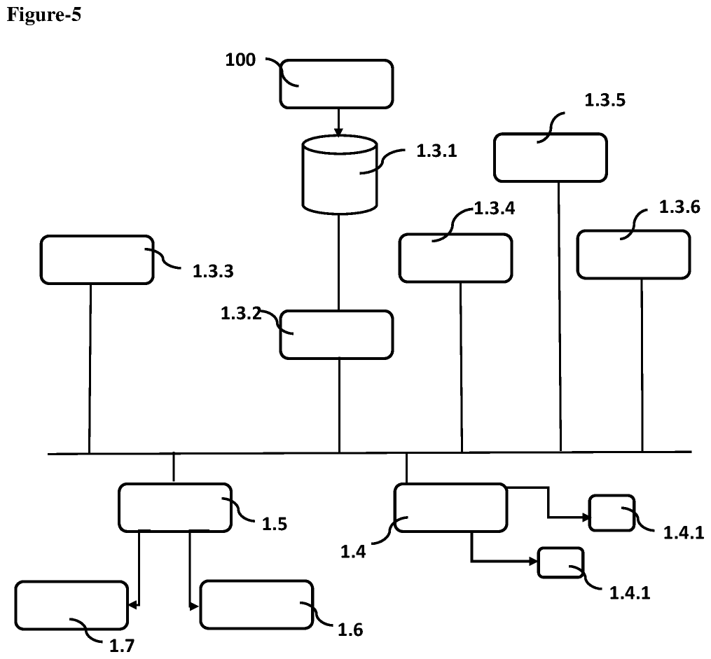

The figure (FIG. 5) describes the way the invention works and how the interaction between the components works. The method (100) is all the calculations and the software side of the invention explained in (FIG. 4) and all that information's including audio tags and/or the position of the tag and/or and/or all the related info is stored in a local storage unit (1.3.1) or a cloud storage unit (1.3.1). Input/output unit (1.3.2) comprises any input/output devices including the other controllers and/or USB interface and/or including any storage unit attached to the device (1) and/or all of this is shared with the central processing unit (1.3.3) and/or other elements using the system bus which communicate between the different units inside the device (1).

The network adapter (1.3.5) has all the networking capability of the device (1) including wireless (wi-fi, bluetooth . . . etc) functionality and the communication adapter (1.3.4) helps the network adapter (1.3.5) communicate with the central processing unit (1.3.3) through the system bus.

The user interface (1.5) element is controlled and navigated through voice mainly as well as a set of control element (1.7) to navigate the augmented environment. As well as a set of stereo speakers (1.6) to inside the device (1) to be able to listen to the tagged items. The display adapter (1.4) is responsible for displaying all the graphics and calculating the geometries and it communicate with the central processing unit (1.3.3) through the system bus. The display adapter (1.4) then output to the displays (1.4.1) of the device (1) which there is two of to create a stereoscopic image view of the world.

The big advantage of the invention is the ability to navigate the world through voice and audio tagging and using it as the main way to control the environment meanwhile all the other VR devices (1) use visual as the main instrument to immerse the user while neglecting the voice almost entirely. The invention tries to create a new segment of devices (1) that are based on voice and vocal interaction while maintaining the visual aspect and improving it even more.

The invention is not limited to the above exemplary embodiments, and a person skilled in the art can readily put forward embodiments of the invention. These are considered within the scope of the invention as claimed by the accompanying claims.

1. A virtual reality device (1) for including voice as a tool to add value and extra layer of information to the virtual environment; comprising at least one image acquisition unit (1.1) for recording the environment and for augmenting into the virtual world and the real-world environment in the outside of the device (1), at least one speaker (1.6) is inside the device (1) for using playback the recorded audio of the user and/or if the user interact with other users, it for recording any users the things they heard and their own comment on it, at least one strap (1.8) for holding the device (1) to the user head in the predetermined length and thickness and at least one sensor (1.9) for calculating distance from the device (1) to the object user is looking at and focusing on; characterized in that it comprises at least one inner image acquisition unit (1.1) for recording the eye movement and determine the convergence and meiosis of the object captured by the said outer image acquisition unit (1.1), at least one inner voice acquisition unit (1.2) for recording the audio in stereo from the user while tagging the object on the focus which means that after determining the focal point with the user eyes then the voice acquisition unit's (1.2) starting record what the user is saying and record that as a tag to the object in the virtual world, at least one user interface (1.5) for ensuring the items such as menus, buttons, etc. that allows user to see and interact with them, at least one control/calculating unit (1.3) for controlling and navigating through an user interface (1.5), at least one peripheral display (1.4.1) for maintaining the stereoscopic illusion connected with at least one display adapter (1.4) is responsible for displaying all the graphics and calculating the geometries and it communicate with the central processing unit (1.3.3) through the system bus and then output to the displays (1.4.1) of the device (1) which there is two of to create a stereoscopic image view of the world.

2. The virtual reality device (1) according to claim 1, characterized in that, wherein the control/calculating unit (1.3) comprising at least one storage unit (1.3.1), which stores the audio tags and/or the position of the tag and/or all related information, at least one input/output unit (1.3.2) which comprise any input/output devices including the other controllers and/or USB interface and/or including any storage unit attached to the device (1) and/or all of this is shared with the central processing unit (1.3.3) and/or other elements using the system bus which communicate between the different units inside the device (1), at least one central processing unit (1.3.3) for doing all the calculation needed for the invention to function, at least one communication adapter (1.3.4) which is the chip responsible of communicating with the network adapter (1.3.5), at least one network adapter (1.3.5) has all the networking capability of the device (1) including wireless (wi-fi and/or bluetooth . . . etc) functionality and the communication adapter (1.3.4) helps the said network adapter (1.3.5) communicate with the central processing unit (1.3.3) through the system bus and at least one sensing unit (1.3.6) including all the sensors necessary for the function of the device (1).

3. The virtual reality device (1) according to claim 2, characterized in that, it comprises at least one control element (1.7) for simulating hand movement in the virtual world and controlling the user interface (1.5) with it.

4. A method (100) of the device (1) subject to the invention comprise the following working steps;
the device (1) starts receiving data from at least one front image acquisition unit (1.1) (101) and calibrate the position of the user in the virtual environment (102)
meanwhile at least one image acquisition unit (1.1) positioned to inside the device (1) to record and detect the movement of the eyes pupil are calculating the convergence point in the environment to detect the point which the user is currently focusing on if the process is not finished successfully the said image acquisition units (1.1) start looking for meiosis in the pupil in the process (103)
if that process failed then the device (1) start receiving information from the image acquisition units (1.1) again or if the process is concluded successfully on either step of (102) or (103) then the device (1) start detecting the use speech input (104)
and at least one voice acquisition unit (1.2) on the device (1) start to record the digital audio (converting the analog audio to digital encoded audio file) from the user (106) and then add a tag marker on the point detected by the previous processes (102) and (103) which conclude the process (107).
